(19) United States
(12) Patent Application Publication
(10) Pub. No.: US 2012/0133224 A1
(43) Pub. Date: May 31, 2012

(54) ARC RESISTANT TERMINAL BLOCK

(76) Inventors: Andrew P. Grosskopf, Rockford, IL (US); Aaron M. Finke, Janesville, WI (US); Douglas J. Turner, Rockford, IL (US)

(21) Appl. No.: 12/955,340

(22) Filed: Nov. 29, 2010

(51) Int. Cl. H01R 9/24; H01B 17/00; H02K 11/00; H01R 13/02

(52) U.S. Cl. 310/71; 439/884; 174/176; 439/709

(57) ABSTRACT

An arc resistant terminal block has a terminal post insulator and a terminal lead strap that increase the strike and creep distance of electrically charged components to grounded components by non-conductive terminal block and insulators.

### BACKGROUND

The present application is directed to a generator or a generator/motor including a terminal block, and more specifically to an arc resistant terminal block design.

Oil cooled electric generators include connection terminals that connect the generator to an external electrical system, thereby allowing the generator to act as a power source for the electric system. The connection terminals include conductive and non-conductive sealing components that prevent oil within the generator from leaking out of the generator, while still allowing the conductive electrical connections to protrude from the generator to provide electrical power.

In normal conditions at altitude or adverse conditions, such as an over-voltage, the generator terminals can undergo an arc-fault during which electricity can arc over a strike distance (pass through the air between two non-contacting conducting components) or a creep distance (pass over non-conducting components connecting two conducting components). Arc events occur when the voltage of the terminals exceeds an amount accounted for in the minimum strike and creep distances of the electric terminal. Further influencing arc events are the atmospheric pressure, cleanliness of surfaces and the ambient conditions. For this reason components, such as terminals, which are used in external or exposed positions can have longer minimum strike and creep distance requirements than terminals used within a controlled environment.

### SUMMARY

Disclosed is a generator and/or generator/motor having a terminal connection assembly with a terminal lead insulator received in a terminal block slot, a terminal post extending through the insulator and the terminal block slot, a terminal lead strap electrically contacting the terminal post, and a threaded terminal electrically contacting the terminal lead strap.

Also disclosed is a terminal lead assembly having a terminal post with an exterior end and a terminal lead strap contacting said exterior end. The terminal lead strap has a pair of angled edges.

Also disclosed is a terminal lead insulator having a ring with a plurality of protrusions extending radially outward from the ring. The ring also has a first extension section extending axially from the ring beyond the plurality of protrusions in a first direction and a second section extending axially from the ring beyond the plurality of protrusions in a second direction.

Also disclosed is a terminal block having a plurality of terminal lead slots, wherein each of the terminal lead slots has a recessed section for receiving a terminal lead insulator extension and an open section for receiving terminal leads.

Also disclosed is a method for assembling an arc resistant terminal block having the steps of inserting a terminal lead post into an insulator ring, inserting the insulator ring into a generator, fitting a terminal block about the terminal lead posts and the insulator ring, and installing a terminal lead strap contacting the terminal lead post.

### BRIEF DESCRIPTION OF THE DRAWINGS

The disclosure can be further understood by reference to the following detailed description when considered in connection with the accompanying drawings wherein:

FIG. 1 schematically illustrates an example generator and/or generator/motor having an external facing terminal.

FIG. 2 illustrates an example terminal connection assembly.

FIG. 3 illustrates a terminal lead assembly for use in the example terminal connection assembly of FIG. 2.

FIG. 4A illustrates the terminal lead strap of FIG. 3 isolated from the terminal lead assembly.

FIG. 4B illustrates the terminal lead strap of FIG. 3 isolated from the terminal lead assembly in a front view.

FIG. 5A illustrates a side view of a terminal lead insulator for use in an example terminal connection assembly.

FIG. 5B illustrates a top view of a terminal lead insulator for use in an example terminal connection assembly.

FIG. 6A illustrates a bottom view of a terminal block for use in an example terminal connection assembly.

FIG. 6B illustrates a top view of the terminal block of FIG. 6A.

FIG. 7 illustrates a sectional view of an example terminal connection assembly.

FIG. 8 illustrates an isometric view of an example terminal connection assembly.

### DETAILED DESCRIPTION

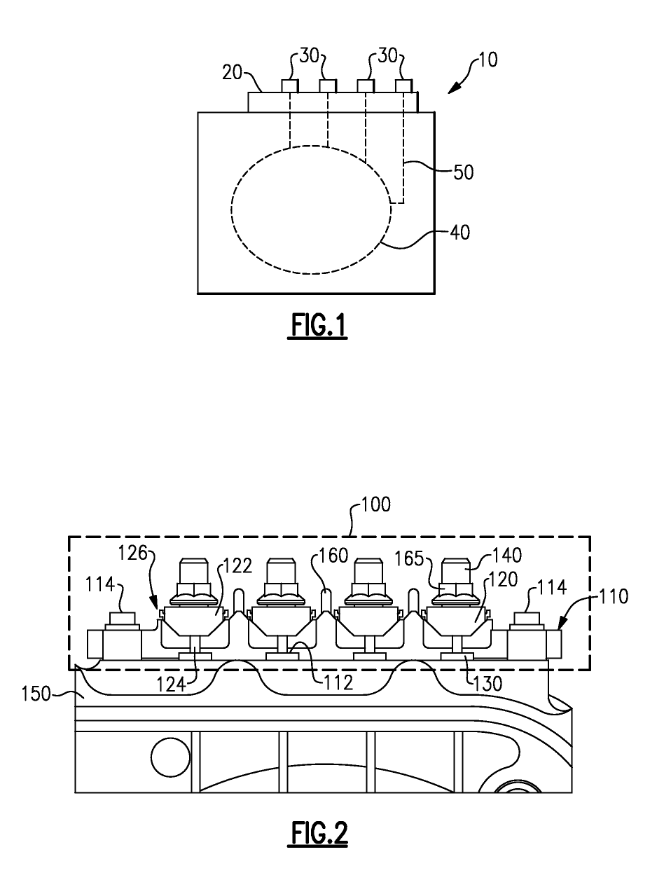

Illustrated in FIG. 1 is a schematic drawing of a generator and/or generator/motor assembly 10. The generator assembly 10 includes a terminal connection assembly 20. The terminal connection assembly 20 has multiple terminal connections 30 for connecting the generator assembly 10 to an electrical system. Each of the terminal connections 30 are connected to a generator winding 40 via a terminal to winding connection 50.

FIG. 2 illustrates a more detailed terminal connection assembly 100 (corresponding to the terminal connection assembly 20 of FIG. 1). The terminal connection assembly 100 includes a terminal block 110 that is fastened to a generator housing 150 using multiple fasteners 114. Additionally, the terminal block 110 includes a plurality of terminal block isolation ridges 160 that separate each of multiple threaded terminal 140. Passing through the terminal block 110 are a plurality of terminal lead assemblies 120. Each of the terminal lead assemblies 120 has a terminal post 124 that connects the terminal to winding connection 50 (illustrated in FIG. 1) to a terminal lead strap 122. In the illustrated example of FIG. 2, a square washer 126 is used to hold the terminal lead assembly 120 in place. The threaded terminal 140 provides a post for connecting the terminal lead assembly 120 to the electric system.

The terminal lead assembly 120 is further held in place, and isolated from the generator housing 150, using a terminal lead insulator 130. The terminal lead insulator 130 fits into a terminal post slot 112 in the terminal block 110. The terminal lead insulator 130 increases both the minimum creep distance and the minimum strike distance of the terminal connection assembly 100 through the use of a terminal lead insulator extension, as described below.

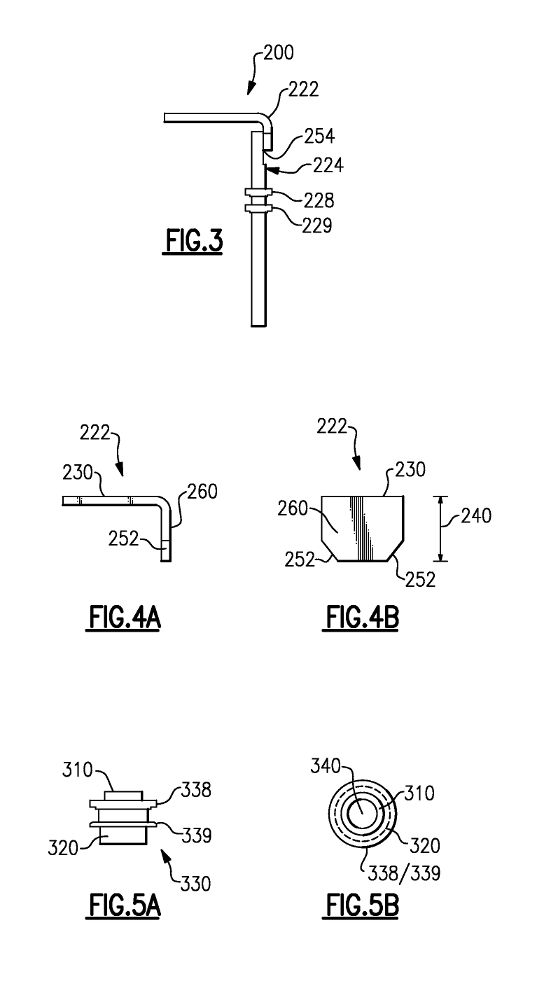

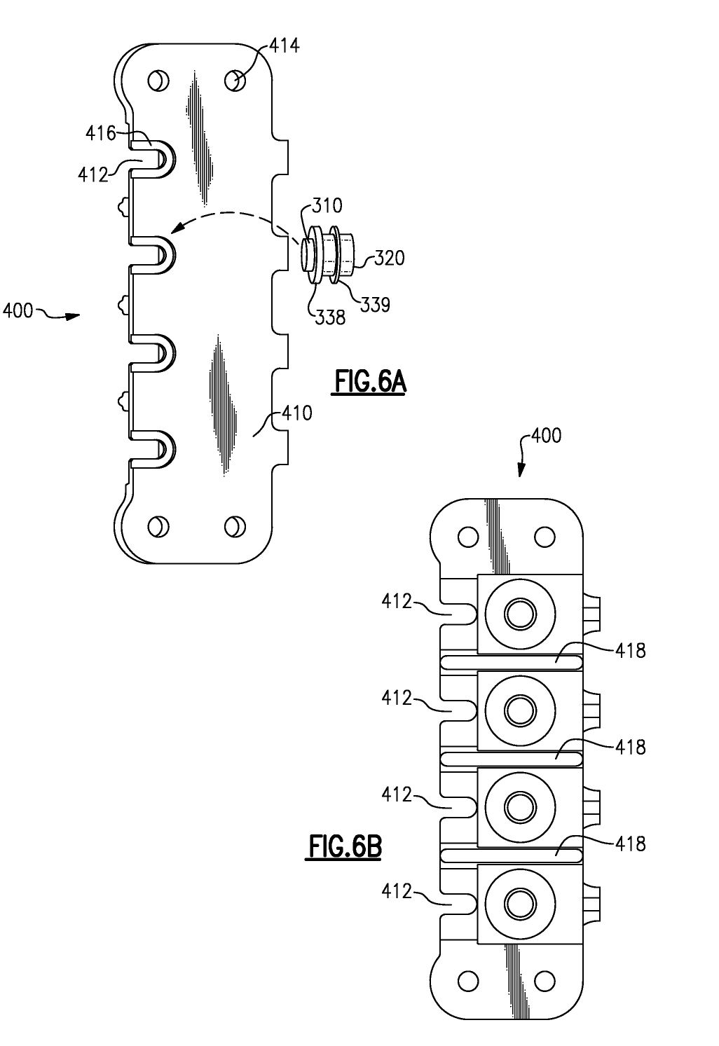

An example terminal lead assembly 200 is illustrated in FIG. 3. The terminal lead assembly 200 has a terminal lead strap 222 and a terminal post 224. The terminal post 224 includes an upper terminal post seal protrusion 228 and a lower terminal post seal protrusion 229 that extend radially outward from the terminal post 224. When the terminal lead assembly 200 is installed in the generator body, an o-ring (illustrated in FIG. 7) is located between the upper and lower seal protrusions 228, 229 thereby preventing oil inside the generator from leaking out between the terminal post 224 and the terminal lead insulator 330. When installed, each of the seal protrusions 228, 229 is within the terminal lead insulator 330 (illustrated in FIGS. 5A and 5B).

FIGS. 4A and 4B illustrate an example terminal lead strap 222, in a side view (FIG. 4A) and a front view (FIG. 4B). The terminal lead strap 222 includes an exterior end 230 and a folded end 260. The exterior end 230 contacts the threaded terminal 140 (illustrated in FIG. 2). The folded end 260 contacts the terminal post 224 at a contact edge 254 (illustrated in FIG. 3). The terminal lead strap 222 and the terminal post 224 can be brazed together such that the terminal lead assembly is an inseparable assembly. In this way, a conductive path between the terminal post 224 and the threaded terminal 140 is maintained. The corners of the folded end 260 of the terminal lead strap 222 are angled with a pair of angled edges 252. The angled edges 252 get closer together progressively along a length 240 of the folded end 260, thereby increasing the strike distance by eliminating the corners of the folded end 260.

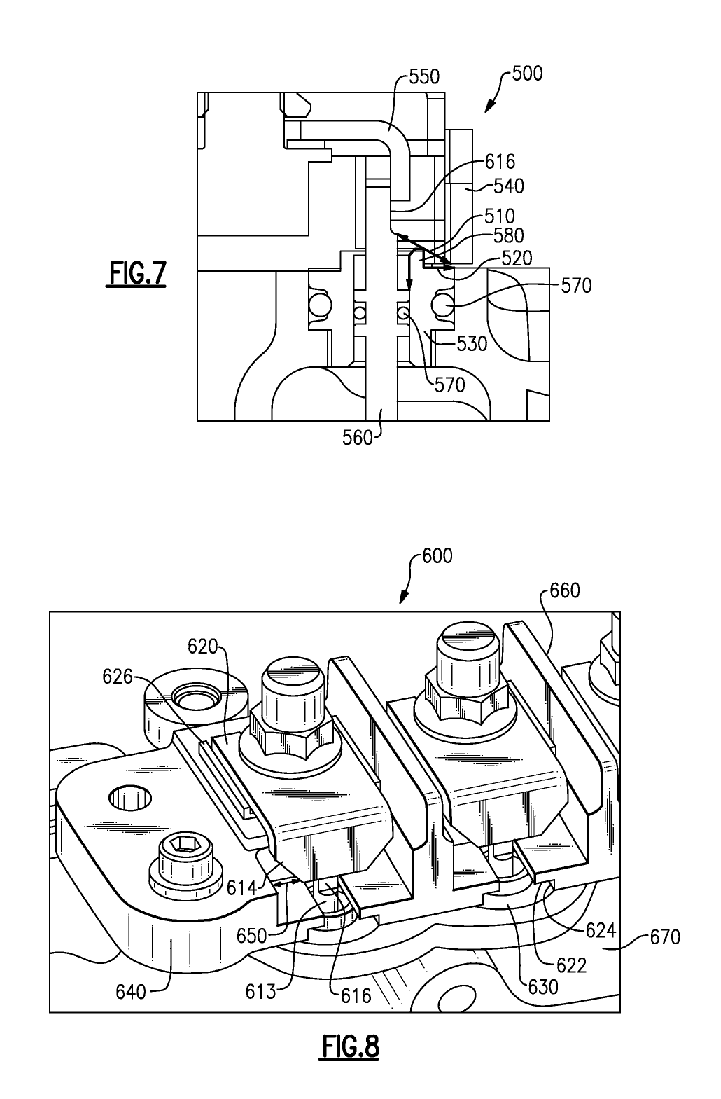

FIGS. 5A and 5B illustrate the terminal lead insulator 330 isolated from the terminal connection assembly 100 of FIG. 2. FIG. 5A illustrates a side view, and FIG. 5B illustrates a top view. The terminal lead insulator 330 is a ring of non-conductive material, and has an upper seal protrusion 338, a lower seal protrusion 339, and a through hole 340. The terminal lead insulator 330 further includes an upper insulator extension 310 that fits into an insulator extension slot 416 (illustrated in FIG. 6A) in the terminal block 110. The upper insulator extension 310 increases the creep distance and the strike distance of the terminal connection assembly 100 as is described below with regards to FIG. 7. A lower body portion 320 is also included as part of the terminal lead insulator 330. The lower body portion 320 has a larger radial thickness than the upper insulator extension 310.

As with the terminal lead assembly 200, an o-ring is located between the seal protrusions 338, 339 when the terminal lead insulator 330 is installed, thereby fully sealing the terminal post and the terminal lead insulator 330 in the generator body. While the above descriptions include an o-ring seal design, it is understood that alternate seal designs could be used in place of an o-ring style seal and maintain the effectiveness of the present disclosure.

FIGS. 6A and 6B illustrate a terminal block 400 in an underside view (FIG. 6A) and a top view (FIG. 6B). The terminal block 400 includes a set of terminal post slots 412 and recessed terminal extension slots 416. The upper insulator extension 310 of the terminal lead insulator 330 fits within the terminal block 400 in the recessed terminal extension slot 416 and the terminal post 224 extends through the terminal post slot 412. The terminal block 400 further includes multiple fastener holes 414 for fastening the terminal block 400 to the generator housing.

The terminal block 400 includes isolation ridges 418 between each of the terminal post slots 412 and their adjacent terminal post slots 412. The terminal isolation ridges 418 allow for a cap to be fitted to the terminal connection after the generator is connected to an electric system, thereby protecting the terminal connection assembly 100. The terminal isolation ridges 418 further increase the distance of strike and creep zones that can be created as a result of a buildup of grime or other materials by providing an insulative barrier between the connection terminals.

A cross-sectional view of a connection assembly 500 is illustrated in FIG. 7 and shows a terminal lead assembly installed in the terminal connection assembly 500. Also illustrated in FIG. 7 are the terminal lead insulator 530 and a terminal block 540. The terminal block 540 can be the terminal block 400 illustrated in FIGS. 6A and 6B. The terminal lead insulator 530 and the terminal post 560 are sealed to the generator housing a pair of o-rings 570. The o-rings 570 are a conventional design and prevent oil leakage because the o-ring elastomer creates the seal based on the inner and outer diameters of the rigid surfaces. The upper and lower protrusions of the terminal post 560 and the terminal lead insulator 530 prevent the o-rings 570 from sliding up or down, thereby maintaining the seal. The minimum strike distance 510 and the minimum creep distance 520 of the terminal connection assembly are also illustrated. Also shown connected to the terminal post 560 is a terminal lead strap 550.

The upper insulator extension 580 increases the creep distance 520 of the terminal assembly by increasing the length of the surface over which electrical charge must creep before an arc event can occur. Likewise the upper insulator extension 580 increases the strike distance 510 by placing an isolative barrier in the shortest distance between the conducting post 560 and the conductive generator housing. Increasing the creep distance 520 and the strike distance 510 reduces the risk of arc events within the connection assembly 500.

FIG. 8 illustrates a partial isometric view of the terminal connection assembly 600 connected to a generator body 670, including the terminal lead strap 620. The terminal lead strap 620 is brazed to contact edge 616, which provides the electrical contact between the terminal lead strap 620 and the terminal post 613. An additional feature of the terminal strap 620 is the angled edge 614. As described with regards to FIGS. 4A and 4B, the angled edge 614 increase the strike distance 650 between the lead strap and the terminal block 640. The increased distance prevents an arc from jumping the gap between the lead strap and terminal block. Although FIG. 8 illustrates the angled edge 614 as a straight edge it is understood that a curved edge or multiple angled edges could also increase minimum strike distance, rather than the illustrated straight edge 614.

Furthermore, as described with regards to FIG. 2, the terminal lead strap 620 is held in place between the terminal block isolation ridges 660 by a square washer 626, and the terminal post 613 is held in place via a terminal lead insulator 630. The terminal lead insulator 630 includes an insulator extension, which is received in a terminal extension slot defined by a first surface 622 and a second surface 624.

In order to construct the above described terminal connection assembly 100, the described components are combined into a single assembly. First, the terminal post 124 receives an o-ring between the seal protrusions 228, 229 and is inserted into the center of the terminal lead insulator ring 130. Then the terminal lead insulator ring 130 receives an o-ring between the terminal lead insulator protrusions 338, 339 and is inserted into a terminal lead hole in the generator. Next, the terminal block 110 is fitted about the terminal lead insulator ring extensions 310 such that each of the extensions 310 fits in a recessed terminal lead insulator ring extension slot 416 and each of the terminal lead posts 124 extends through an open terminal post slot 412.

Next, the terminal block 110 is fastened to the generator housing fasteners 114 and a terminal lead strap 122 is connected to each terminal lead post 124. In an alternate example, the terminal lead strap 122 and the terminal post 124 are brazed together prior to the step of inserting the terminal post 124 into the terminal lead insulator ring 130. The terminal lead strap 122, and by extension, the terminal post 124, is held in place with a square washer 126. Once assembled, the threaded terminal nut 165 can be connected to the terminal lead straps 122 in a known fashion, thereby allowing the generator to be connected to an external electrical system.

Although an example has been disclosed, a worker of ordinary skill in this art would recognize that certain modifications would come within the scope of the claims. For that reason, the following claims should be studied to determine their true scope and content.

What is claimed is:

1. A generator having a terminal connection assembly comprising:
a terminal lead insulator at least partially received in a terminal block slot;
a terminal post having an exterior end and extending through said insulator and said terminal block slot;
a terminal lead strap electrically contacting said terminal post; and
a threaded terminal electrically contacting said terminal lead strap.

2. The generator of claim 1, wherein said terminal lead insulator comprises:
a ring;
a plurality of protrusions extending radially outward from said ring;
a first extension section extending axially from said ring beyond said plurality of protrusions in a first direction; and
a second section extending axially from said ring beyond said plurality of protrusions in a second direction.

3. The generator of claim 2, wherein said terminal lead insulator comprises a single, non-conductive piece.

4. The generator of claim 1, wherein said terminal lead strap comprises a pair of angled edges.

5. The generator of claim 4, wherein said terminal lead strap comprises a contact end for contacting an electrical connector, a folded end for contacting said terminal post exterior end, and said pair of angled edges are on said folded end.

6. The generator of claim 5, wherein said folded end comprises a first edge and a second edge opposite the first edge, and wherein a distance between said first edge and said second edge is progressively smaller along a length of said folded end.

7. The generator of claim 6, wherein said length is defined by a terminal post axis.

8. The generator of claim 6, wherein said first edge and said second edge are said pair of angled edges.

9. The generator of claim 1, further comprising a plurality of terminal lead slots, wherein each of said terminal lead slots comprises a recessed section for receiving a terminal lead insulator extension and an open section for receiving terminal leads.

10. The generator of claim 9, wherein said terminal block comprises a non-conductive material.

11. The generator of claim 9, further comprising a plurality of fasteners attaching said terminal block to a terminal assembly.

12. The generator of claim 9, wherein said terminal block further comprises a plurality of isolation ridges, wherein each of said isolation ridges separates adjacent terminal lead slots.

13. A terminal lead assembly comprising:
a terminal post having an exterior end; and
a terminal lead strap having a pair of angled edges, and contacting said exterior end.

14. The terminal lead assembly of claim 13, wherein said terminal lead strap comprises a contact end for contacting an electrical connector, and a folded end for contacting said terminal post exterior end.

15. The terminal lead assembly of claim 14, wherein said folded end comprises a first edge and a second edge opposite the first edge, and wherein a distance between said first edge and said second edge is progressively smaller along a length of said folded end.

16. The terminal lead assembly of claim 15, wherein said length is defined by a terminal post axis.

17. The terminal lead assembly of claim 15, wherein said first edge and said second edge are said pair of angled edges.

18. The terminal lead assembly of claim 13, wherein said terminal post and said terminal strap are brazed together such that said terminal post and said terminal strap form an inseparable assembly.

19. A terminal lead insulator comprising:
a ring;
a plurality of protrusions extending radially outward from said ring;
a first extension section extending axially from said ring beyond said plurality of protrusions in a first direction; and
a second section extending axially from said ring beyond said plurality of protrusions in a second direction.

20. The terminal lead insulator of claim 19, wherein said first extension section has a first radial thickness, said second section has a second radial thickness, and said first radial thickness is different from said second radial thickness.

21. The terminal lead insulator of claim 19, wherein said terminal lead insulator comprises a single, non-conductive piece.

22. A terminal block comprising:
a plurality of terminal lead slots, wherein each of said terminal lead slots comprises a recessed section for receiving a terminal lead insulator extension and an open section for receiving terminal leads.

23. The terminal block of claim 22, wherein said terminal block comprises a non-conductive material.

24. The terminal block of claim 22, further comprising a plurality of fasteners for attaching said terminal block to a terminal assembly.

25. The terminal block of claim 22, wherein said terminal block further comprises a plurality of isolation ridges, wherein each of said isolation ridges separates adjacent terminal lead slots.

26. A method for assembling an arc resistant terminal block comprising the steps of:
inserting a terminal lead post into an insulator ring;
inserting said insulator ring into a generator;
fitting a terminal block about said terminal lead posts and said insulator ring; and
installing a terminal lead strap contacting said terminal lead post.

27. The method of claim 26, further comprising the additional step of securing said terminal lead strap using a square washer.

28. The method of claim 26, wherein said step of fitting a terminal block about said terminal lead posts and said insulator rings further comprises fitting an insulator ring extension in a terminal block recess, thereby increasing arc and creep distances.

29. The method of claim 26, further comprising the step of brazing said terminal lead strap to said terminal lead post.
